(19) United States
(12) Patent Application Publication
(10) Pub. No.: US 2010/0143751 A1
(43) Pub. Date: Jun. 10, 2010

(54) MAGNETIC RECORDING MEDIA HAVING LOW BROADBAND NOISE

(75) Inventors: Meng C. Hsieh, St. Paul, MN (US); Ruth M. Erkkila, St. Paul, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: IMATION CORP., Oakdale, MN (US)

(21) Appl. No.: 12/706,378

(22) Filed: Feb. 16, 2010

Related U.S. Application Data
(63) Continuation-in-part of application No. 11/035,911, filed on Jan. 14, 2005.

(51) Int. Cl. G11B 5/716; G11B 5/33

(52) U.S. Cl. 428/840; 428/800

(57) ABSTRACT

A dual-layer magnetic recording tape having a non-magnetic substrate with a front side and a back side, a lower support layer formed over the front side and a magnetic recording layer formed over the lower support layer. The magnetic recording layer includes magnetic metallic pigment particles having an average particle length up to about 35 nm, and a coercivity of at least about 2,000 Oersteds. The magnetic tape has a BB noise less than about −91 dB at about 93 kfci.

### REFERENCE TO RELATED APPLICATION

This application is a continuation-in-part of U.S. application Ser. No. 11/035,911, filed Jan. 14, 2005, the contents of which are incorporated herein by reference.

### FIELD OF THE INVENTION

The present invention relates generally to magnetic recording media such as a magnetic tape, more specifically to a magnetic recording medium having a magnetic layer comprising magnetic metallic pigment particles having an average particle length up to about 35 nm.

### BACKGROUND OF THE INVENTION

Magnetic recording media are widely used in data recording tapes, audio tapes, video tapes, computer tapes, disks and the like. The magnetic recording media generally includes a substrate over which a magnetic recording layer is formed.

It is desirable to enhance the amount of data that may be stored on the magnetic recording media. However, it is generally desirable for the magnetic recording media to conform to particular form factors to facilitate using the magnetic recording media on equipment that is designed to be used with the particular form factor of the magnetic recording media.

For example, the size and shape of data storage tape cartridges are typically limited by the equipment on which the data storage tape cartridge is intended to be used. Accordingly, increasing the data storage density of the magnetic recording tape is typically viewed as the only way to increase the data storage capacity of the data storage tape cartridge.

A large percentage of the commercially available magnetic recording tape includes a magnetic recording layer that is formed from magnetic metallic particles. These have a magnetic core of metallic (i.e., reduced, unoxidized, uncombined) iron, cobalt, or alloys of these with each other or with other metals. A shell of oxidized metal, and other compounds, is generally formed around this core to provide protection against corrosion of the core. These metallic particles are dispersed in binders and then coated on the substrate, with or without intervening layers of largely nonmagnetic character.

The magnetic recording medium is formed on a non-magnetic substrate. Conventionally used substrate materials include polyesters such as polyethylene terephthalate (PET), polyethylene naphthalate (PEN), and mixtures thereof; polyolefins (e.g., polypropylene); cellulose derivatives; polyamides; and polyimides.

While the metallic particle magnetic recording layer includes many advantageous characteristics, the recording density of metallic particle magnetic recording media is generally viewed as being limited by the nature of the metallic particles.

Two routes have been explored to increase the data storage capacity of magnetic recording tape. The first route is to increase the data storage density of metallic particle magnetic recording tape, typically through the use of smaller and/or better-dispersed metallic particles. The second route is to identify other materials that may be used to form the magnetic recording layer on the magnetic recording tape. This application focuses on the first approach, which is advantageous from the viewpoint of economic considerations and compatibility with existing equipment. Such an approach has required significant progress in dispersing and coating smaller metallic particles.

In certain designs, the magnetic coating (or “front coating”) is formed as a single layer directly onto a non-magnetic substrate. In an alternative approach, a dual-layer construction is employed more frequently, including a lower support layer on the substrate and a thin magnetic recording layer formed directly on the support or lower layer. The layers may be formed simultaneously or sequentially. With this type of construction, the lower support layer is generally thicker than the magnetic layer.

The support layer is typically non-magnetic and generally comprised of a non-magnetic powder dispersed in a binder. Conversely, the upper layer comprises one or more magnetic metallic particle powders or pigments dispersed in a binder system. The formulation for the magnetic layer is optimized to maximize the performance of the magnetic recording medium in such areas as signal-to-noise ratios, pulse width, and the like.

Magnetic tapes may also have a backside coating applied to the opposing side of the non-magnetic substrate to improve the durability, electrical conductivity, and tracking characteristics of the media. As with the front coatings, the backside coatings are typically combined with a suitable solvent to create a homogeneous mixture that is then coated onto the substrate, after which the coating is dried, calendered if desired, and then cured. The formulation for the backside coating or layer also comprises pigments and a binder system.

As an alternative to forming the magnetic recording layer from metallic particles, magnetic recording tapes have been fabricated using other materials such as hexagonal ferrites, e.g., barium ferrite, in the magnetic recording layer. One document that describes forming magnetic recording tape using barium ferrite is Yamazaki, U.S. Patent Publication No. 2003/0072969. This publication indicates that the barium ferrite recording layer allows data storage density of the magnetic recording tape to be increased.

The use of barium ferrite in the magnetic recording layer of a magnetic recording tape is discussed in A Recording Density Study of Advanced Barium Ferrite Particulate Tape, IEEE Transactions on Magnetics, Vol. 42, pp. 2312-2314 (2006).

Since the IEEE article was published in 2006 and the current application was filed in January 2005, the IEEE article is not prior art with respect to the current application but rather is cited to show the relationship between metallic particle magnetic recording tape and barium ferrite magnetic recording tape.

As illustrated by the AFM and MFM images of barium ferrite particulate tape and metallic particulate tape in FIGS. 3 and 5 of the IEEE article, the barium ferrite particulate tape and the metallic particulate tape have different physical structures.

As illustrated by the graphs in FIGS. 4, 6 and 7 of the IEEE article, the barium ferrite particulate tape and the metallic particulate tape have different signal to noise ratios, isolated pulse waveforms and frequency responses, respectively.

The lower noise of the barium ferrite particulate tape enhances the signal to noise ratio of the magnetic recording tape when compared to metallic particle magnetic recording tape. The IEEE article concludes by noting that barium ferrite particulate tape has a recording density of about 7 Gbits/inch² and, as such, is thought to hold considerable promise as a next-generation particulate tape.

Because of the different properties of metallic particle magnetic recording tape and barium ferrite magnetic recording tape, it is generally not possible to use barium ferrite magnetic recording tape with conventional equipment that is used for reading and writing metallic particle magnetic recording tape.

It is generally believed that reading heads must be more sensitive to accommodate the lower magnetic moment of barium ferrite. The different pulse shapes shown in the IEEE article reference indicate that different signal-processing electronics would be needed for barium ferrite as well.

It would be desirable to have a magnetic recording tape having a magnetic particle smaller than that which has been previously used.

It has now been discovered that a magnetic recording medium that includes a magnetic recording layer comprising magnetic metallic pigment particles having an average particle length up to about 35 nm, and a coercivity of at least about 2000 Oersteds, has a broadband (BB) noise of less than about ±91 dB at about 93 kfci.

### SUMMARY OF THE INVENTION

The invention provides a dual-layer magnetic recording tape comprising a non-magnetic substrate having a front side and a back side, a lower support layer formed over the front side and a magnetic recording layer formed over the lower support layer, comprising magnetic metallic pigment particles having an average particle length up to about 35 nm, and a coercivity of at least about 2000 Oersteds, wherein the magnetic tape has a BB noise less than about ±91 dB at about 93 kfci.

In one embodiment, the invention provides a magnetic recording medium having a front side and a back side, a lower support layer formed over the front side and a magnetic recording layer formed over the lower support layer. The magnetic recording layer includes magnetic metallic pigment particles having an average particle length up to about 35 nm, and a coercivity of at least about 2000 Oersteds, wherein the magnetic tape has a BB noise less than about ±92 dB at about 131 kfci.

The substrate has a magnetic coating coated onto the front side, and may have a backside coating on the opposing side of the substrate. The magnetic layer may contain one or more metallic particulate pigments, and a binder system therefor.

With a ferromagnetic magnetic recording layer, there may also be an optional support layer or sublayer that is coated directly onto the substrate and, in such cases, the magnetic recording layer is coated atop the sublayer. An optional back coating may be formed on the opposing surface of the substrate that includes carbon black dispersed in a binder.

In one embodiment, the invention provides a magnetic recording tape having longitudinal tracks comprising a non-magnetic substrate having a front side and a backside, a lower support layer formed over the front side and a magnetic recording layer formed over the lower support layer. The magnetic recording layer includes magnetic metallic pigment particles having an average particle length up to about 35 nm, and a coercivity of at least about 2000 Oersteds, wherein the magnetic recording tape has a BB noise less than about ±92 dB at about 131 kfci.

These terms when used herein have the following meanings.

1. The term “coating composition” means a composition suitable for coating onto a substrate.

2. The terms “layer” and “coating” are used interchangeably to refer to a coated composition.

3. The terms “back coating” and “backside coating” are synonymous and refer to a coating on the opposing side of the substrate from a magnetic layer.

4. The term “vinyl” when applied to a polymeric material means that the material comprises repeating units derived from vinyl monomers. When applied to a monomeric material, the term “vinyl” means that the monomer contains a moiety having a free-radically polymerizable carbon-carbon double bond.

5. The term “resistivity” means the surface electrical resistance measured in Ohms/square.

6. The term “Tg” means glass transition temperature.

7. The term “coercivity” means the intensity of the magnetic field needed to reduce the magnetization of a ferromagnetic material to zero after it has reached saturation, taken at a saturation field strength of 10,000 Oersteds.

8. The term “Oersted,” abbreviated as “Oe,” refers to a unit of magnetic field intensity.

9. The term “Broadband noise,” usually abbreviated “BB noise,” is the average integrated broadband noise power expressed in decibels (dB). This value is obtained by a procedure described in ECMA International Standard 319.

10. The term “Broadband Signal-to-Noise Ratio,” usually abbreviated “BBSNR,” is the ratio of average signal power to average integrated BB noise power of a tape clearly written at density TRD2, expressed in decibels (dB). The BB noise is measured as the integrated noise power under the frequency curve from 4.5 KHz to 15.8 MHz. This value is obtained by a procedure described in ECMA International Standard 319.

11. The term “tape” is used synonymously with the term “magnetic recording medium” and means a substrate coated with at least a magnetic coating on the front side of the substrate.

12. The term “dB” means decibel. The term includes both singular and plural. All weights, amounts and ratios herein are by weight, unless otherwise specifically noted.

### DETAILED DESCRIPTION OF THE PREFERRED EMBODIMENTS

The magnetic recording medium includes a substrate and a magnetic layer. In certain embodiments, the magnetic recording medium may also include a sublayer and a backside layer. The various components are described in greater detail below. In general terms, however, the magnetic layer includes at least one magnetic metallic pigment and a binder system for the pigment.

In certain embodiments, the magnetic recording medium may be a dual-layer magnetic recording medium having a support layer coated on the front side of the substrate, with the magnetic layer being coated atop the support layer.

It has been discovered that increased data storage densities may be attained by forming a dual-layer magnetic recording tape with a magnetic recording layer formed from magnetic metallic pigment particles having an average particle length up to about 35 nm and a coercivity of at least about 2000 Oersteds, which provides a magnetic recording tape having a BB noise of less than about −91 dB at about 93 kfci.

By increasing the recording density of the metallic particle magnetic recording tape, the claimed invention enables production of high capacity data storage tapes without the need to modify the equipment used in conjunction reading and/or writing data onto the metallic particle magnetic recording tape as would be necessary to use barium ferrite magnetic recording tape.

In light of the preceding comments, the significant differences between the structures and performance of metallic particle magnetic recording tape and barium ferrite magnetic recording tape indicates that it is not appropriate to compare characteristics exhibited by barium ferrite magnetic recording tape with characteristics exhibited by metallic particle magnetic recording tape because barium ferrite magnetic recording tape is a major technology shift from metallic particle magnetic recording tape and would require changes in the system used to record and read the magnetic recording tape.

The Magnetic Recording Layer

In accordance with the current invention, the magnetic recording layer is a thin layer containing magnetic particle pigments. The magnetic recording layer may have a thickness of between about 1 microinch (0.025μ) and about 10 microinches (0.25μ). In certain embodiments, the magnetic recording layer may have a thickness of between about 1 microinch and about 8 microinches.

Magnetic recording tapes of the invention include at least one particulate magnetic metallic pigment having an average particle length of less than about 35 nm. Useful particles have coercivities of at least about 1,800 Oe and, in certain embodiments, at least about 2,000 Oe. The magnetic metallic particle pigments have a composition including metallic iron and/or alloys of iron with cobalt and/or nickel, and may include materials chosen from magnetic or non-magnetic oxides of iron, other elements, or mixtures thereof.

To improve the required characteristics, the preferred magnetic powder may contain at least one additive, such as semi-metal or non-metal elements and their salts or oxides such as Al, Nd, Si, Co, Y, Ca, Mg, Mn, Na, etc.

The selected magnetic powder may be treated with various auxiliary agents before it is dispersed in the binder system, resulting in the primary magnetic metallic particle pigment. Useful pigments according to the invention have an average particle length no greater than about 35 nanometers (nm). Use of these pigments in magnetic recording layers of dual-layer magnetic recording tapes provide tapes having excellent BB noise characteristics, as measured according to ECMA Standard 319.

This ECMA standard specifies the physical and magnetic characteristics of magnetic tape cartridges, using magnetic tape 12.65 mm wide so as to provide physical interchange of such cartridges between drives. It also specifies the quality of the recorded signals, the recording method and the recorded format, thereby allowing data interchange between drives by means of such cartridges.

In Annex B of such standard, broadband noise values are defined and procedures for measure set out. Magnetic tape under 3.5 ounces of tension is run at 3 meters/second over a Certance Gen 2 LTO head. For measurements made at 93 kfci, noise is measured in the presence of a 1,830 flux transition per millimeter (ftpmm) signal at 21 frequencies between 0 and 15.5 MHz, and the standard tape amplitude is measured at 3660 ftpmm and 5.49 MHz. For measurements made at 131 kfci, noise is measured in the presence of a 2,593 flux transition per millimeter (ftpmm) signal at 21 frequencies between 0 and 15.5 MHz, and the standard tape amplitude is measured at 5,187 ftpmm and 7.78 MHz.

The magnetic recording tapes of the invention have BBSNR ratios of less than about −91 dB when tested at about 93 kfci. In certain embodiments, a dual-layer magnetic recording tape of the invention has a BBSNR ratio of less than about −92 dB when tested at about 131 kfci.

In addition to the primary magnetic metallic particle pigment described above, the magnetic layer may further include soft spherical particles. Most commonly these particles are comprised of carbon black. A small amount, such as less than about 3%, of at least one large particle carbon material may also be included. In certain embodiments, spherical carbon particles may be used.

The large particle carbon materials have a particle size on the order of from about 50 to about 500 nm. In certain embodiments, the particle size of the carbon materials is between about 70 and about 300 nm. Spherical large carbon particle materials are known and commercially available, and in commercial form can include additives such as sulfur to improve performance. The remainder of the carbon particles present in the upper layer are small carbon particles, i.e., the particles have a particle size on the order of less than 100 nm and, in certain embodiments, less than about 50 nm.

The magnetic layer may also include an abrasive or head cleaning agent (HCA) component. One suitable HCA component is aluminum oxide. Other abrasive grains such as silica, ZrO₂, Cr₂O₃, etc., can also be employed, either alone or in mixtures with aluminum oxide or each other.

The binder system associated with the magnetic layer may incorporate at least one binder resin, such as a thermoplastic resin, in conjunction with other resin components such as binders and surfactants used to disperse the HCA, a surfactant (or wetting agent), and one or more hardeners.

In certain embodiments, the binder system of the magnetic layer includes at least one hard resin component and at least one soft resin component in conjunction with the other binder components. Hard resin components typically have a glass transition temperature (Tg) of at least about 70° C., and soft resin components typically have a glass transition temperature of less than about 68° C.

In certain embodiments, the binder system contains at least one binder resin, such as a thermoplastic resin, in conjunction with other resin components such as binders and surfactants used to disperse the HCA, a surfactant (or wetting agent), and one or more hardeners. In one embodiment, the binder system of the magnetic recording layer includes a combination of a primary polyurethane resin and a vinyl chloride resin.

Examples of suitable polyurethanes include polyester-polyurethane, polyester-polyurethane, polycarbonate-polyurethane, polyester-polycarbonate-polyurethane, and polycaprolactone-polyurethane. Other suitable vinyl chloride resins such as vinyl chloride-vinyl acetate copolymer, vinyl chloride-vinyl acetate-vinyl alcohol copolymer, and vinyl chloride-vinyl acetate-maleic anhydride can also be employed with the primary polyurethane binder. Resins such as bis-phenyl-A-epoxy, styrene-acrylonitrile, and nitrocellulose may also be used.

The binder system may also include an HCA binder used to disperse the selected HCA material, such as a polyurethane paste binder (in conjunction with a pre-dispersed or paste HCA). Alternatively, other HCA binders compatible with the selected HCA format (e.g., powder HCA) may be used. As with other ingredients, HCA may be added to the main dispersion separately or dispersed in the binder system, and then added to the main dispersion.

The magnetic layer may further contain one or more lubricants such as a fatty acid and/or a fatty acid ester. The incorporated lubricant(s) exists throughout the front coating and, importantly, at the surface thereof of the magnetic layer.

The lubricant(s) reduces friction to maintain smooth contact with low drag, and protects the media surface from wear. In dual-layer media, lubricant(s) are generally provided in both the upper and lower layers, and may be selected and formulated in combination.

Preferred fatty acid lubricants include at least 90 percent pure stearic acid. Although technical grade acids and/or acid esters can also be employed for the lubricant component, incorporation of high purity lubricant materials ensures robust performance of the resultant medium. Other acceptable fatty acids include one or more of myristic acid, palmitic acid, oleic acid, etc., and mixtures thereof. The magnetic layer formulation can further include one or more fatty acid esters such as butyl stearate, isopropyl stearate, butyl oleate, butyl palmitate, butyl myristate, hexadecyl stearate, and oleyl oleate.

In certain embodiments, the lubricant is incorporated into the magnetic layer at a concentration of between about 1 and about 10 parts by weight, based on 100 parts by weight of the primary pigment. In other embodiments, the lubricant may be provided at a concentration of between about 1 and about 5 parts by weight.

The binder system may also contain a conventional surfactant or wetting agent. Known surfactants, e.g., adducts of sulfuric, sulfonic, phosphoric, phosphonic, and carboxylic acids, may be used.

The coating composition may also contain a hardening agent such as isocyanate or polyisocyanate. In certain embodiments, the hardener component is incorporated into the upper layer in an amount of from about 1 to about 5 parts by weight, based on 100 parts by weight of the primary magnetic pigment. In other embodiments, the hardening agent may be provided at a concentration of between about 1 and about 3 parts by weight.

The materials for the magnetic layer may be mixed with the primary pigment and coated atop the lower layer. Useful solvents associated with the upper layer coating material may include cyclohexanone (CHO) having a concentration of between about 5% and about 50%, methyl ethyl ketone (MEK) having a concentration of between about 40% and about 90%, and toluene (Tol) having a concentration of between about 0% and about 40%. Alternatively, other ratios can be employed, or even other solvents or solvent combinations including, for example, xylene, methyl isobutyl ketone, tetrahydrofuran, and methyl amyl ketone, may be used.

The Lower Support Layer

The lower support layer of a dual-layer magnetic tape of the invention may be essentially non-magnetic and may include non-magnetic powders and a resin binder system. By forming one or more essentially non-magnetic lower layers, the electromagnetic characteristics of the magnetic layer are not adversely affected.

The lower layer of magnetic recording media of the invention may include at least a primary pigment and a binder system therefor. Such support layers are used in combination with an upper magnetic layer to form a magnetic recording medium having high quality recording characteristics and good mechanical and handling properties.

The primary lower layer pigment material may consist primarily of non-magnetic particles such as iron oxides, titanium dioxide, alumina, tin oxide, titanium carbide, silicon carbide, silicon dioxide, silicon nitride, boron nitride, and the like.

In certain embodiments, the primary lower layer pigment material is a hematite material (α-iron oxide) that can be acidic or basic in nature. In other embodiments, alpha-iron oxides are substantially uniform in particle size and annealed to reduce the number of pores. After annealing, the pigment is ready for surface treatment, which is typically performed prior to mixing with other layer materials such as carbon black and the like. Alpha-iron oxides are well known and are commercially available from Dowa Mining Company, Toda Kogyo, Sakai Chemical Industry Co., and others.

Conductive carbon black material provides a certain level of conductivity so as to provide the formulation with protection from charging with static electricity. The conductive carbon black material may be of a conventional type and widely commercially available. In certain embodiments, the conductive carbon black material has an average particle size of less than 20 nm. In other embodiments, the conductive carbon black material has an average particle size of about 15 nm.

The support or lower layer may also include an alumina containing pigment. In certain embodiments, such pigment is an aluminum oxide pigment. Other abrasive grains such as silica, ZrO₂, Cr₂O₃, etc., can also be employed, either alone or in mixtures with aluminum oxide. Such pigments are frequently referred to as head cleaning agents (HCA) due to the abrasive nature of the pigments.

The binder system or resin associated with the lower layer may incorporate at least one binder resin, such as a thermoplastic resin, in conjunction with other components. Additional components may include binders and surfactants used to disperse the HCA, a surfactant (or wetting agent), and one or more hardeners. The binder system of the support layer contain a hard resin along with a soft resin. The soft resin may have a Tg of less than about 68° C. The hard resin may have a Tg of at least about 70° C.

The coating composition further may include an additional binder used as a dispersant, such as a polyurethane paste binder.

The binder system may also contain a conventional surfactant or wetting agent. Known surfactants, e.g., adducts of sulfuric, sulfonic, phosphoric, phosphonic, and carboxylic acids, are acceptable.

The binder system may also contain a hardening agent such as isocyanate or polyisocyanate. In certain embodiments, the hardener component is incorporated into the lower layer at a concentration of between about 2 and 5 parts by weight, based on 100 parts by weight of the primary lower layer pigment. In other embodiments, the hardening agent is provided at a concentration of between about 3 and 4 parts by weight.

The support layer may further contain one or more lubricants such as a fatty acid and/or a fatty acid ester. As with the magnetic layer, the support layer includes stearic acid which is at least about 90% pure. Other acceptable fatty acids include myristic acid, palmitic acid, oleic acid, etc., and their mixtures. The support layer formulation can further include a fatty acid ester such as butyl stearate, isopropyl stearate, butyl oleate, butyl palmitate, butyl myristate, hexadecyl stearate, and oleyl oleate.

The fatty acids and fatty acid esters may be employed singly or in combination. The lubricant may be incorporated into the lower layer at a concentration of between about 1 and about 10 parts by weight, based on 100 parts by weight based on the primary lower layer pigment combination. In certain embodiments, the lubricant may be provided at a concentration of between about 1 and about 5 parts by weight.

The materials for the lower layer may be mixed with the primary pigment and the lower layer is coated to the substrate. Useful solvents associated with the lower layer coating material preferably include cyclohexanone (CHO) having a concentration of between about 5% and about 50%, methyl ethyl ketone (MEK) having a concentration of between about 40% and about 90%, and toluene (Tol) having a concentration of up to about 40%. Alternatively, other ratios can be employed, or even other solvents or solvent combinations including, for example, xylene, methyl isobutyl ketone, tetrahydrofuran, and methyl amyl ketone, are acceptable.

Substrate

Magnetic recording media of the invention comprise a magnetic recording medium for use with a magnetic recording head, comprising a substrate having a magnetic layer formed over the front side of the substrate, which comprises magnetic pigment particles, and a binder system therefor. The magnetic recording medium has a cross-web dimensional difference from the magnetic recording head of less than about 900 microns/meter over a 35 degree temperature range, and over a 70% relative humidity range, e.g., from 10% to 80% relative humidity.

Suitable substrates for use in a magnetic recording medium of the invention include, in addition to polymer films, metal, metal alloys, and glass films. In at least one embodiment comprising a substrate having a magnetic layer formed thereover, the magnetic recording medium has a cross-web dimensional expansional difference from that of the magnetic recording head of less than 500 microns/meter over a 70% relative humidity range, e.g., from 10% to 80% relative humidity.

The Back Coat

The back coat primarily consists of a soft non-magnetic particle material such as carbon black or silicon dioxide particles. In one embodiment, the back coat layer comprises a combination of two kinds of carbon blacks, including a primary, small carbon black component and a secondary, large texture carbon black component, in combination with appropriate binder resins.

The primary, small carbon black component may have an average particle size on the order of between about 10 and about 50 nm. The secondary, large carbon component may have an average particle size on the order of between about 50 and about 300 nm. The back coat of the magnetic recording medium of the present invention contains from between about 25 and about 50 percent small particle carbon particles based on total composition weight based on total composition weight. In certain embodiments, the small particle carbon particles may have a concentration of between about 35 and about 50 percent.

Back coat pigments are dispersed as inks with appropriate binders, surfactant, ancillary particles, and solvents. In certain embodiments, the back coat binder includes at least one of a polyurethane resin, a phenoxy resin, and nitrocellulose blended appropriately to modify coating stiffness as desired.

Useful solvents to create dispersions of the invention include methyl ethyl ketone, toluene, and cyclohexanone, and mixtures thereof, as well as other solvents or solvent combinations including, for example, xylene, methyl isobutyl ketone, and methyl amyl ketone, are acceptable.

Process for Manufacture

In a magnetic recording medium using a particulate magnetic recording layer, the coating materials of the upper layer, lower layer, if any, and back coat may be prepared by dispersing the corresponding powders or pigments and the binders in a solvent. For example, with respect to the coating material for the upper layer, the primary metallic particle powder or pigment and the large particle carbon materials may be placed in a high solids mixing device along with certain of the resins (i.e., polyurethane binder, non-halogenated vinyl binder, and surfactant) and the solvent, and processed for between about 1 and about 4 hours.

The resulting material is processed in a high-speed impeller dissolver along with additional amounts of the solvent for between about 30 to about 90 minutes. Following this letdown processing, the resulting composition may be subjected to a sandmilling or polishing operation.

Subsequently, the HCA and related binder components may be added, and the composition left standing for between about 30 and about 90 minutes. Following this letdown procedure, the composition may be processed through a filtration operation, and then stored in a mixing tank at which time the hardener component and lubricants may be added. The resulting upper layer coating material is then ready for coating.

Preparation of a sublayer coating, when such a layer is used, entails a similar process, including high solids mixing of the pigment combination including the primary lower layer pigment, conductive carbon black material, and HCA with the binder and a solvent, for between about 2 and about 4 hours.

Finally, preparation of the back coat coating material entails mixing the various components, including a solvent, in a planetary mixer or similar device, and then subjecting the dispersion to a sandmilling operation. Subsequently, the material may be processed through a filtration operation in which the material is passed through a number of filters.

The process for manufacture of this type of magnetic recording medium may include an in-line portion and one or more off-line portions. The in-line portion may include unwinding the substrate or other material from a spool or supply. The substrate is coated with the backcoating on one side of the substrate, and next the backside coating is dried, typically using conventional ovens.

A front coating is applied to the substrate. For the dual-layer magnetic recording media of the invention, the sublayer or support layer is applied first, directly onto the substrate, and the magnetic coating is then coated atop the support layer.

For single layer magnetic recording media, the magnetic layer is coated directly atop the substrate. Alternatively, the front coating can occur prior to the backcoating. The coated substrate is magnetically oriented and dried, and then proceeds to the in-line calendaring station.

According to one embodiment, called compliant-on-steel (COS), in-line calendering uses one or more in-line nip stations, in each of which a steel or other generally non-compliant roll contacts or otherwise is applied to the magnetically coated side of the substrate, and a rubberized or other generally compliant roll contacts or otherwise is applied to the back coated side. The generally non-compliant roll provides a desired degree of smoothness to the magnetically coated side of the substrate.

Alternately, the in-line calendering is “steel-on-steel” (SOS), meaning both opposing rolls are steel. The process may also employ one or more nip stations each having generally non-compliant rolls. After in-line calendaring, the substrate or other material is wound. The process then proceeds to an off-line portion that may occur at a dedicated stand-alone machine.

The coated substrate is unwound and then is calendered. The off-line calendering may include passing the coated substrate through a series of generally non-compliant rollers, e.g., multiple steel rollers, although materials other than steel may be used. The coated, calendered substrate then is wound a second time. The wound roll is then slit, burnished, and tested for defects according to methods known in the industry.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention.

Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

### EXAMPLES

The following table lists the physical attributes along with the BB noise results measured at about 93 kfci for magnetic tapes.

### Examples 1-3

Examples 1-3 in Table 1 are dual-layer tapes having a magnetic upper layer and non-magnetic lower layer coated on a PEN substrate. In addition, each of the tapes has a back coat on the opposite side of the substrate to the magnetic layer. Both the magnetic layer and non-magnetic sublayer use a binder system comprising a PVC-vinyl copolymer (MR 104) and a commercially available polyurethane (UR-4122) polymer.

In addition to the binders, the formulation contains a mixture of fatty acid (stearic acid) and fatty acid esters (butyl stearate and palmitate) as lubricants, alumina as a head cleaning agent, and carbon particles. The magnetic particles used in these examples are acicular metallic particles with a long axis length and coercivity as indicated in Table 1. Magnetic orientation was carried out in a conventional manner by passing the coated tape through 10 magnetic coils while the magnetic and sublayer coatings were in the process of drying.

After drying, the tape was in-line steel-on-steel calendered followed by off-line steel-on-steel calendering.

Examples 1-3 illustrate the effect of reducing the MP length and achieving improved BBSNR as compared to Comparative Example C1. Example C5 further illustrates the effect of reducing the MP particle length for improved BBSNR relative to Example C4. Examples 3 and C6 were used to show that while BBSNR may differ from run-to-run, the BB noise stays at the same levels. Example 3 and C6 were coated on the same day. Example 2 is paired with C5 and Example 1 is paired with C4.

### Comparative Examples C4-C6

Examples C4-C6 in Table 1 are dual-layer magnetic recording tapes that are coated similar to those tapes in Examples 1-3, except that they use magnetic pigment particles in the upper magnetic recording layer which are larger than 35 nm, as indicated in Table 1.

TABLE 1

| | | | BB noise | BB noise | BBSNR |
|---|---|---|---|---|---|
| | MP Length | Coercivity | at 93 | at 131 | at 93 |
| Example | (nm) | (Oe) | kfci (dB) | kfci (dB) | kfci (dB) |
| 1 | 35 | 2280 | −92.36 | −92.48 | 27.6 |
| 2 | 35 | 2268 | −92.30 | −92.33 | 27.8 |
| 3 | 35 | 2269 | −92.05 | −92.32 | 29.5 |
| C4 | 60 | 2716 | −88.05 | −88.82 | 26.8 |
| C5 | 45 | 2375 | −90.96 | −90.67 | 27.9 |
| C6 | 45 | 2375 | −90.67 | −90.83 | 29.5 |

It is contemplated that features disclosed in this application, as well as those described in the above applications incorporated by reference, can be mixed and matched to suit particular circumstances. Various other modifications and changes will be apparent to those of ordinary skill.

1. A dual-layer magnetic recording tape comprising:
a non-magnetic substrate having a front side and a back side;
a lower support layer formed over the front side; and
a magnetic recording layer formed over the lower support layer, wherein the magnetic recording layer comprises magnetic metallic pigment particles having an average particle length up to about 35 nm, and a coercivity of at least about 2,000 Oersteds, wherein the magnetic tape has a BBSNR of at least about 27 dB at about 93 kfci.

2. The dual-layer magnetic recording tape of claim 1, wherein the dual-layer magnetic recording tape has a BB noise less than about ±91 dB at about 93 kfci.

3. The dual-layer magnetic recording tape of claim 1, wherein the dual-layer magnetic recording tape has a BB noise less than about ±92 dB at about 131 kfci.

4. The dual-layer magnetic recording tape of claim 1, wherein the dual-layer magnetic recording tape has an average magnetic side surface smoothness no greater than about 6 nm, as measured by atomic force microscopy.

5. The dual-layer magnetic recording tape of claim 1, wherein the magnetic recording layer further comprises a binder system for the magnetic pigment particles.

6. The dual-layer magnetic recording tape of claim 5, wherein the binder system comprises at least two resin components.

7. The dual-layer magnetic recording tape of claim 6, wherein one of the resin components is a polyurethane resin.

8. The dual-layer magnetic recording tape of claim 6, wherein one of the resin components is a vinyl chloride resin.

9. The dual-layer magnetic recording tape of claim 1, wherein the magnetic recording layer further comprises a particulate carbon material.

10. The dual layer magnetic recording tape of claim 1, wherein the magnetic recording layer comprises:
a primary magnetic metallic pigment;
aluminum oxide;
a spherical large particle carbon material having an average particle size of between about 50 and 500 nm;
a polyurethane binder;
a vinyl chloride binder;
a hardener;
a fatty acid ester lubricant; and
a fatty acid lubricant.

11. The dual-layer magnetic recording tape of claim 1, wherein the lower support layer comprises a pigment powder selected from a substantially non-magnetic or soft magnetic powder, having a coercivity of less than 300 Oe, and a resin binder system therefor.

12. The dual-layer magnetic recording tape of claim 11, wherein the lower support layer further comprises:
a fatty acid ester lubricant;
a fatty acid lubricant; and
a conductive carbon black material dispersed in the binder.

13. The dual-layer magnetic recording tape of claim 12, wherein the conductive carbon black comprises less than about 5 weight percent of the lower support layer.

14. The dual-layer magnetic recording tape of claim 1, and further comprising a back coat coated on the back side of the substrate.

15. The dual-layer magnetic recording tape of claim 14, wherein the back coat comprises:
a carbon black pigment;
a urethane binder; and
at least one compound selected from phenoxy resin and nitrocellulose.

16. The dual-layer magnetic recording tape of claim 14, wherein the back coat further comprises a metal oxide selected from titanium dioxide, aluminum oxide and combinations thereof.

17. The dual-layer magnetic recording tape of claim 1, wherein the magnetic metallic particle pigments comprise metallic iron; an alloy of iron with cobalt, nickel, or cobalt and nickel; a magnetic oxide of iron, a non-magnetic oxide of iron, or any mixture of the preceding materials.

18. The dual-layer magnetic recording tape of claim 1, wherein the magnetic recording layer is devoid of barium ferrite.

19. A magnetic recording tape comprising:
a non-magnetic substrate having a front side and a backside;
a lower support layer formed over the front side; and
a magnetic recording layer formed over the lower support layer, wherein the magnetic recording layer comprises magnetic metallic pigment particles having an average particle length up to about 35 nm, and a coercivity of at least about 1,800 Oersteds, wherein the magnetic recording tape has a BBSNR of at least about 27 dB at about 93 kfci.

20. The magnetic recording tape of claim 19, wherein the magnetic recording tape has a BB noise of less than about −92 dB at about 131 kfci.

21. The magnetic recording tape of claim 19, wherein the magnetic recording tape has longitudinal tracks.

22. The magnetic recording tape of claim 19, wherein the magnetic metallic pigment particles have a coercivity of at least about 2,000 Oersteds.

23. The magnetic recording tape of claim 19, wherein the magnetic recording layer is devoid of barium ferrite.
